(19) United States
(12) Patent Application Publication
(10) Pub. No.: US 2007/0060147 A1
(43) Pub. Date: Mar. 15, 2007

(54) Apparatus for transmitting data packets between wireless sensor networks over internet, wireless sensor network domain name server, and data packet transmission method using the same

(76) Inventors: Young Sam Shin, Daejeon (KR); Hee Seok Choi, Daejeon (KR); Il Gon Park, Seoul (KR); Seung Min Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/491,823

(22) Filed: Jul. 24, 2006

(30) Foreign Application Priority Data
Jul. 25, 2005 (KR) 10-2005-0067341

(51) Int. Cl. H04Q 7/20

(52) U.S. Cl. 455/445

(57) ABSTRACT

Provided are an apparatus for transmitting data packets between wireless sensor networks over the Internet, a wireless sensor network domain name server, and a data packet transmission method using the same. The data packet transmission apparatus includes: a radio frequency (RF) interface; an ethernet interface; and a network processor connected between the RF interface and the ethernet interface for converting a data packet input/output between a wireless sensor network and the Internet and sending the converted data packet through a corresponding interface. By sending a desired data packet using an Internet communication tunnel over the Internet, the data packet transmission apparatus, wireless sensor network domain name server, and data packet transmission method allow a user to access a wireless sensor network over the Internet anytime and anywhere, interwork directly with the Internet rather than through another server, and perform remote monitoring and control operations.

### CROSS-REFERENCE TO RELATED APPLICATION

This application claims priority to and the benefit of Korean Patent Application No. 2005-67341, filed on Jul. 25, 2005, the disclosure of which is incorporated herein by reference in its entirety.

### BACKGROUND

1. Field of the Invention

The present invention relates to an apparatus for transmitting data packets between wireless sensor networks over the Internet, a wireless sensor network domain name server, and a data packet transmission method using the same. More particularly, the present invention relates to an apparatus for transmitting data packets between wireless sensor networks over the Internet, a wireless sensor network domain name server, and a data packet transmission method using the same, which can interwork directly with the Internet without a separate server and allow a user to connect to the wireless sensor networks over the Internet by converting a header of a data packet output from a wireless sensor network and sending the data packet through the Internet to another wireless sensor network.

2. Discussion of Related Art

In general, a wireless sensor network comprises a media access control (MAC) protocol layer for radio frequency (RF) communication, and a routing protocol layer for controlling an entire network and setting up a data packet transmission route.

Inter-layer interface and header format is predetermined for call processing and data packet transmission of each layer. Wireless sensor nodes can exchange information each other, based on the predetermined format.

In a conventional wireless network for ubiquitous computing, data packets are collected from a sink node, which is a wireless sensor node directly connected to a monitoring server. In addition, each sensor node is controlled by the monitoring server.

However, the conventional monitoring server has to be physically connected to a sink node of a wireless sensor network to which it desires to be connected, in order to interwork with the Internet and perform remote monitoring and control functions. The network cannot be substantially extended by data packet conversion and the remote connection can be achieved only through a corresponding monitoring server.

In addition, considering characteristics of an Ad-Hoc wireless sensor network, the conventional art mentioned above is not effective for network extension and cannot provide a substantial interworking function between a wireless sensor network and the Internet.

### SUMMARY OF THE INVENTION

The present invention provides an apparatus for transmitting data packets between wireless sensor networks over the Internet, a wireless sensor network domain name server, and a data packet transmission method using the same, which can interwork directly with the Internet without a separate server and allow a user to connect to the wireless sensor networks over the Internet by converting a header of a data packet output from a wireless sensor network and sending the data packet through the Internet using an Internet communication tunnel (UDP tunnel: user datagram protocol tunnel) to another wireless sensor network.

One aspect of the present invention provides an apparatus for transmitting data packets between wireless sensor networks over the Internet, comprising: a radio frequency (RF) interface; an Ethernet interface; and a network processor connected between the RF interface and the ethernet interface for converting a data packet input/output between a wireless sensor network and the Internet and sending the converted data packet through a corresponding interface, wherein a desired data packet is sent over the Internet using an Internet communication tunnel.

Another aspect of the present invention provides a wireless sensor network DNS, comprising: a first database for storing and managing region names of a plurality of wireless sensor networks; and a second database for storing and managing IP addresses of each data packet transmission apparatus connecting each of the wireless sensor networks to the Internet, wherein a region name of each of the wireless sensor networks is translated into an internet protocol (IP) address of a connectable data packet transmission apparatus with reference to the first and the second databases.

Yet another aspect of the present invention provides a method for transmitting data packets between wireless sensor networks over the Internet, comprising: (a) requesting, at a node X included in a source wireless sensor network, binding information of a destination transmission apparatus for connecting to a node Y included in a destination wireless sensor network, to a source transmission apparatus; (b) sending, at the source transmission apparatus, a query message for obtaining the requested binding information to a wireless sensor network domain name server separately disposed on the Internet, and receiving information about the destination transmission apparatus; (c) sending, at the source transmission apparatus, a binding request message for configuring an Internet communication tunnel to the destination transmission apparatus; and (d) checking, at the destination transmission apparatus, a connection state of the node Y, receiving an active message when the node Y is in an active-state, sending a response message in response to the binding request message to the node X through the source transmission apparatus, and configuring the Internet communication tunnel.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates the overall structure of a system performing a method for transmitting data packets between wireless sensor networks over the Internet according to an exemplary embodiment of the present invention;

FIG. 2 is a block diagram illustrating an apparatus for transmitting data packets between wireless sensor networks over the Internet according to an exemplary embodiment of the present invention;

FIG. 3 illustrates a process in which a data packet output from a wireless sensor network is converted to be included in a user datagram protocol-payload data unit (UDP-PDU) and sent for interworking with the Internet;

FIG. 4 is a conceptual diagram for explaining, in terms of a protocol layer format, conversion of a data packet used in wireless sensor networks and the Internet by an apparatus for transmitting data packets between wireless sensor networks over the Internet according to an exemplary embodiment of the present invention; and

FIG. 5 is a flowchart illustrating a method for transmitting data packets between wireless sensor networks over the Internet according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below, but can be implemented in various types. The present exemplary embodiments are provided for complete disclosure of the present invention and to fully inform the scope of the present invention to those ordinarily skilled in the art.

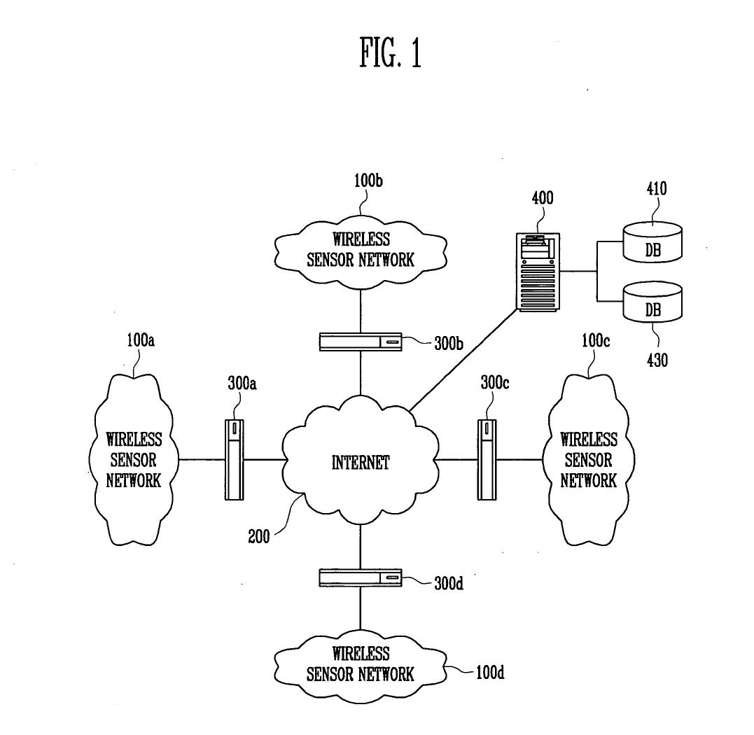

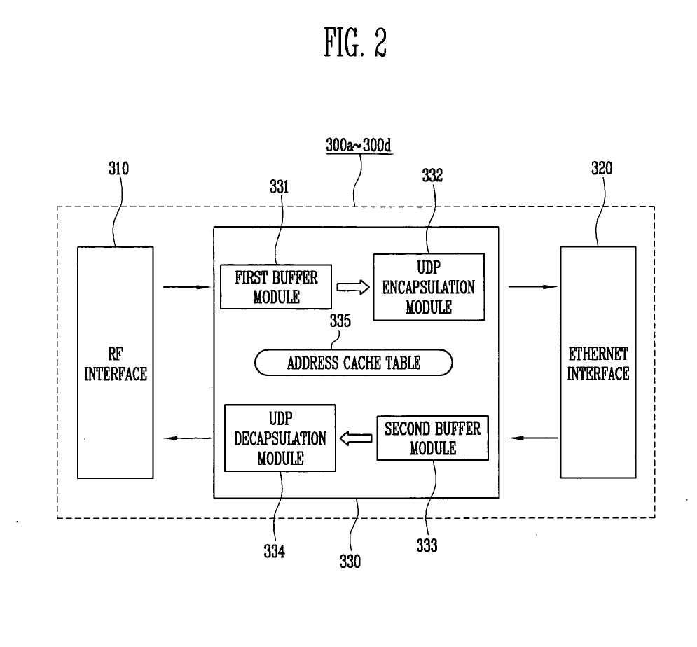

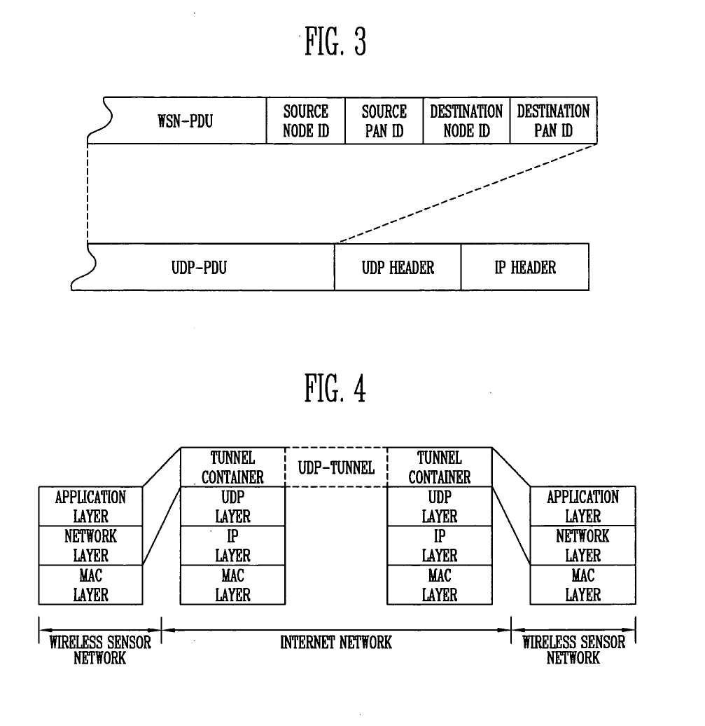

FIG. 1 illustrates the overall structure of a system performing a method for transmitting data packets between wireless sensor networks over the Internet according to an exemplary embodiment of the present invention. FIG. 2 is a block diagram illustrating an apparatus for transmitting data packets between wireless sensor networks over the Internet according to an exemplary embodiment of the present invention. FIG. 3 illustrates a process in which a data packet output from a wireless sensor network is converted to be included in a user datagram protocol-payload data unit (UDP-PDU) and sent for interworking with the Internet.

Referring to FIGS. 1 to 3, a system performing a method for transmitting data packets between wireless sensor networks over the Internet according to an exemplary embodiment of the present invention comprises an Internet 200 and a plurality of wireless sensor networks 100a, 100b, 100c, and 100d connected to the Internet 200.

In addition, data packet transmission apparatuses, i.e., wireless sensor network-gateways (WSN-GWs) 300a, 300b, 300c, and 300d, are respectively provided between the wireless sensor networks 100a to 100d and the Internet 200.

In addition, there exists a separate wireless sensor network-domain name server (WSN-DNS) 400, which can connect to the Internet 200.

Here, each node in the wireless sensor networks 100a to 100d is an independent entity in personal area networks (PANs). In addition, the wireless sensor networks 100a to 100d use an optimized wireless media access control (MAC) protocol and a network protocol.

The wireless sensor networks 100a to 100d are used to integrate physical sensor values such as a temperature, brightness, pressure, and gas composition/concentration into a database and send them as data packets to a destination node.

In addition, the wireless sensor networks 100a to 100d can be configured with ZigBee or ultra wideband (UWB) wireless communication technology, or with a wireless communication technology using an ordinary industrial scientific and medical (ISM) band.

The WSN-GWs 300a to 300d receive a data packet output from a wireless sensor network, convert a header of the data packet, and send the data packet over the Internet 200 through a user datagram protocol (UDP) tunnel configured with a corresponding Internet protocol (IP) address and a UDP port to another computing device, e.g., a remote monitoring server, a mobile personal digital assistant (PDA), a smartphone, etc., or to an extended remote wireless sensor network.

According to the present exemplary embodiment of the present invention, the UDP tunnel is used for communication between the wireless sensor networks. However, the present invention is not limited to this exemplary embodiment, and may use other means for communication between specific devices to protect privacy on the Internet (hereinafter, “Internet communication tunnels”). For example, a communication tunnel can be configured using transmission control protocol (TCP) and so forth and a tunneling identification (ID) can be generated at a different application level to enable communication. However, this example is also a kind of Internet communication using Internet group management protocol (IGMP), IP, UDP, TCP, etc.

As illustrated in FIG. 2, the WSN-GWs 300a to 300d may include a radio frequency (RF) interface 310, an Ethernet interface 320, and a network processor 330.

Here, the RF interface 310 is for connecting to the wireless sensor networks 100a to 100d, and is preferably designed as a socket-type interface including a plurality of modules taking charge of each wireless communication frequency band and/or each communication method so that each module is easily replaced or added. For example, a serial peripheral interface (SPI) scheme, which is a hardware interface scheme for transmitting data between a multipoint conferencing unit (MCU) and an RF module, may be used. The Ethernet interface 320 is for connecting to the Internet 200.

The network processor 330 is connected between the RF interface 310 and the Ethernet interface 320, converts a data packet input/output between the wireless sensor networks 100a to 100d and the Internet 200, and sends the converted data packet through a corresponding interface.

The network processor 330 includes a first buffer module 331, a UDP encapsulation module 332, a second buffer module 333, a UDP decapsulation module 334, and an address cache table 335.

The first buffer module 331 receives a data packet output from the wireless sensor networks 100a to 100d through the RF interface 310, and temporarily stores and then forwards the data packet by a store-and-forward scheme. In other words, the received data packet can be temporarily stored for a time required for timing the forwarding according to a data converting speed and/or a communication environment.

The UDP encapsulation module 332 converts a header of the data packet received from the first buffer module 331 and sends the data packet to the Ethernet interface 320 so that the data packet can be sent to the Internet 200.

As illustrated in FIG. 3, the data packet sent through the UDP encapsulation module 332 includes an Internet communication tunnel identifier including a UDP header and an IP header, and a UDP-PDU (User Datagram Protocol-Payload Data Unit) including a wireless sensor network-payload data unit (WSN-PDU), source/destination wireless sensor network ID and a source/destination node ID within the wireless sensor network.

The second buffer module 333 receives a data packet output from the Internet 200 through the Ethernet interface 320, and temporarily stores and then forwards the output data packet by a typical store-and-forward scheme.

The UDP decapsulation module 334 converts a header of the data packet received from the second buffer module 333 and sends the data packet to the RF interface 310 so that the data packet can be sent to a wireless sensor network 100a, 100b, 100c, or 100d.

The Internet communication tunnel identifier including the UDP header and the IP header has been removed from the data packet sent through the UDP decapsulation module 334. Therefore, only net packet data of a wireless sensor network, i.e., the UDP-PDU including the WSN-PDU and the wireless sensor network ID and the node ID included in the wireless sensor network may be sent through the RF interface 310. Meanwhile, each MAC address required for the transmission is handled by a corresponding interface.

The address cache table 335 is used for converting a header of a data packet and includes the wireless sensor networks Ids and IDs of nodes included in the wireless sensor networks, a UDP port number, and IP addresses of the WSN-GWs 300a to 300d, which are required for configuring the UDP tunnel.

The address cache table 335 is similar to a memory used in a router for storing a routing path table. Specifically, the address cache table 335 is used as a reference table for allocating a kind of random access memory (RAM) to set up a route for data packet transmission, managing the table, and searching for a route.

Each of he WSN-GW 300a to 300d has a node address of a wireless sensor network 100a, 100b, 100c, or 100d and a corresponding MAC address to interwork with the wireless sensor network. In addition, the WSN-GW should have an IP address and an Ethernet MAC address to interwork with the Internet 200, and an IP address of the WSN-DNS 400 to communicate with the WSN-DNS 400.

The WSN-DNS 400 includes a first database (DB) 410 for storing and managing region names, e.g., a PAN ID, an area or local name, a substantially recognizable region name or an administration block name written in English, such as “area1.block2”, and so forth, of the wireless sensor networks 100a to 100d, and a second DB 430 for storing and managing the IP addresses of the WSN-GWs 300a to 300d.

The WSN-DNS 400 is connected to the Internet 200 and translates the region names of each wireless sensor network 100a to 100d into an IP address of a connectable WSN-GW 300a, 300b, 300c, or 300d with reference to the first DB 410 and the second DB 430. Meanwhile, the WSN-DNS 400 can be used in various ways according to an additional application of interworking with the Internet 200.

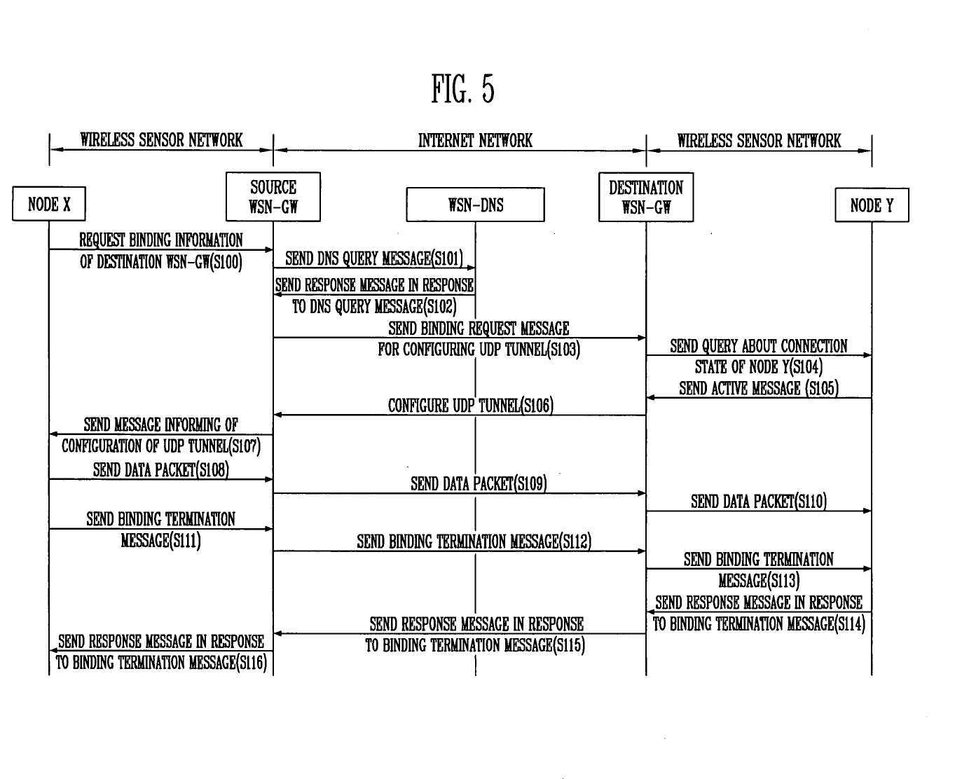

FIG. 4 is a conceptual diagram for explaining, in terms of a protocol layer format, conversion of a data packet used in wireless sensor networks and the Internet by the apparatus for transmitting data packets between wireless sensor networks over the Internet according to an exemplary embodiment of the present invention.

Referring to FIG. 4, the wireless sensor networks 100a to 100d are comprised of a MAC layer and a network layer and exchange user data packets in an application layer.

The MAC layer controls a medium for wireless access, prevents transmission collision, and also performs MAC addressing in the MAC layer.

The network layer performs a routing operation for transmitting a multi-hop data packet and managing a network, and a network addressing operation for management.

Therefore, the address of the wireless sensor network can be divided into a network ID (the same as a WSN-PAN ID) and a node ID of the application layer, and may be used as basic address information for configuring the UDP tunnel.

The UDP tunnel is configured using the address information of each terminal. For example, when a UDP tunnel is configured between a node ID 1 of a WSN-PAN 1 and a node ID 3 of a WSN-PAN 2, socket communication is used through a UDP port between a WSN-GW of the WSN-PAN 1 and a WSN-GW of the WSN-PAN 2.

In other words, as a binding item configuring the UDP tunnel, IP addresses of the node ID 1, PAN ID 1, UDP port number, and WSN-GW should be defined at the WSN-PAN 1 side, and IP addresses of the node ID 3, PAN ID 2, UDP port number, and WSN-GW should be also defined at the WSN-PAN 2 side.

Therefore, an individual end-to-end UDP tunnel can be configured at each node. The addresses required for configuring the UDP tunnel are stored in the address cache table 335, and each node can rapidly send data packets through a secure UDP tunnel. Meanwhile, the UDP tunnel preferably includes the IP addresses of the wireless sensor networks 100a to 100d and UDP port information.

FIG. 5 is a flowchart illustrating a method for transmitting data packets between wireless sensor networks over the Internet according to an exemplary embodiment of the present invention. FIG. 5 shows a signaling route and flow of messages for configuring a UDP tunnel from a source node X included in a source wireless sensor network to a destination node Y included in a destination wireless sensor network.

Referring to FIG. 5, a successive message handling process is shown, in which a request for UDP tunneling from the node X included in the source wireless sensor network, e.g., WSN-PAN 1, to the node Y included in the destination wireless sensor network, e.g., WSN-PAN 2, is sent from the node X to the node Y, the node X obtains the IP address and PAN ID of a destination WSN-GW from the WSN-DNS 400, thereby configuring the UDP tunnel, a data packet is transmitted, and then the UPD tunnel is closed when there is no data packet to be transmitted.

Specifically, when the node X included in the source wireless sensor network WSN-PAN 1 wants to send a data packet through the UDP tunnel to the node Y included in the destination wireless sensor network WSN-PAN 2, first, the node X sends a message to a source WSN-GW requesting binding information, e.g., an IP address and a UDP port number, of the destination WSN-GW for connecting to the node Y (S100). Here, the requested message includes a region name of the node Y.

Subsequently, the source WSN-GW receiving the request message from the node X sends a DNS query (address conversion request) message to the WSN-DNS 400 for obtaining the requested binding information of the destination WSN-GW (S101). Here, the DNS query message includes a region name, e.g., area2.local2, or a PAN ID, of the wireless sensor network WSN-PAN 2 including the node Y.

Subsequently, the WSN-DNS 400 receiving the DNS query message sent from the source WSN-GW sends information about the destination WSN-GW which is capable of connecting to the destination wireless sensor network WSN-PAN 2, i.e., the IP address of the destination WSN-GW and an ID of the destination wireless sensor network WSN-PAN2 (S102).

Then, the source WSN-GW receives the information about the destination WSN-GW and sends a binding request message for configuring the UDP tunnel to the destination WSN-GW (S103). The binding request message includes an ID of the source wireless sensor network WSN-PAN 1, an ID of the node X, an IP address of the source WSN-GW, and a UDP port number.

Subsequently, the destination WSN-GW sends a query about a connection state of the node Y to the node Y (S104), and receives an active message Alive from the node Y when the node Y is in an active-state (S105).

Right after checking the connection state of the node Y, the destination WSN-GW configures the UDP tunnel (S106), and sends a response message in response to the binding request to the node X through the source WSN-GW (S107). Here, the response message to the binding request includes the ID of the destination wireless sensor network WSN-PAN 2, an ID of the node Y, an IP address of the destination WSN-GW, and a UDP port number.

Subsequently, the node X sends a desired data packet through the configured UDP tunnel to the node Y (S108, S109 and S110).

Additionally, when there is no further data packet transmission after sending/receiving the desired data packet(s), a binding termination message is sent/received between the nodes X and Y through the source WSN-GW, the WSN-DNS 400, and the destination WSN-GW to terminate a session of the configured UDP tunnel (S111, S112, S113, S114, S115, and S116). In addition, the binding termination process can be initiated by a node which detects in advance completion of data packet transmission.

Meanwhile, after the UDP tunnel is closed, the binding information is stored in the address cache table 335 for a few minutes, and thus can be effectively used for any further requests.

In addition, when there are a lot of UDP tunnels between the same source and destination WSN-GWs, the UDP tunnels can be multiplexed into one to transmit data packets. A WSN-GW receives the data packets, and then demultiplexes and sends the data packets to corresponding sensor nodes.

According to the apparatus for transmitting data packets between wireless sensor networks over the Internet, wireless sensor network domain name server, and data packet transmission method using the same of the present invention described above, a header of a data packet output from a wireless sensor network is converted, and the data packet is sent to another sensor network. Therefore, the data packet transmission apparatus, wireless sensor network domain name server, and data packet transmission method allow a user to access a wireless sensor network over the Internet anytime, anywhere, interwork directly with the Internet rather than through another server, and perform remote monitoring and control operations. In result, a network can be more effectively configured and extended.

In addition, according to the present invention, a WSN-GW receives a data packet of a wireless sensor network and sends the data packet through a UDP tunnel configured with a corresponding IP address and a UDP port so that a wireless sensor network is effectively controlled and data packets are easily sent/received over the conventional, widely-used Internet.

While the invention has been shown and described with reference to certain exemplary embodiments thereof, it will be understood by those skilled in the art that various changes in form and details may be made therein without departing from the spirit and scope of the invention as defined by the appended claims.

For example, according to an exemplary embodiment of the present invention, since one WSN-GW includes a plurality of PANs and a plurality of nodes are connected to one PAN, a node ID, a PAN ID, and an IP address of a WSN-GW are required to specify a specific node. However, the present invention is not limited to this exemplary embodiment, and the specific node can alternatively be specified with one or two identifier(s) (ID and IP) in a system having a simpler hierarchy structure.

What is claimed is:

1. An apparatus for transmitting data packets between wireless sensor networks over the Internet, comprising:
a radio frequency (RF) interface;
an Ethernet interface; and
a network processor connected between the RF interface and the Ethernet interface for converting an input/output data packet between a wireless sensor network and the Internet and sending the converted data packet through a corresponding interface,
wherein a desired data packet is sent over the Internet using an Internet communication tunnel.

2. The apparatus according to claim 1, wherein the Internet communication tunnel is configured for communication between a specific node of a wireless sensor network connected through the RF interface and a specific node of another wireless sensor network.

3. The apparatus according to claim 1, wherein in the Internet communication tunnel, each node included in the wireless sensor network is identified by a node identifier (ID).

4. The apparatus according to claim 1, further comprising a wireless sensor network domain name server separately disposed on the Internet to store and manage a region name of the wireless sensor network and an Internet protocol (IP) address of the data packet transmission apparatus, and translating a region name of a desired wireless sensor network into an IP address of a connectable data packet transmission apparatus in response to a specific query message.

5. The apparatus according to claim 1, wherein the Internet communication tunnel includes a user datagram protocol (UDP) tunnel.

6. The apparatus according to claim 1, wherein the network processor includes:
a first buffer module for receiving a data packet output from the wireless sensor network through the RF interface, temporarily storing the data packet, and then forwarding the data packet;
a user datagram protocol (UDP) encapsulation module for converting a header of the data packet and sending the converted result to the Ethernet interface such that the data packet forwarded from the first buffer module is sent over the Internet;
a second buffer module for receiving a data packet output through the Ethernet interface from the Internet, temporarily storing the data packet, and then forwarding the data packet; and
a UDP decapsulation module for converting a header of the data packet and sending the converted result to the RF interface such that the data packet forwarded from the second buffer module is sent to the wireless sensor network.

7. The apparatus according to claim 6, wherein the network processor uses a predetermined address cache table to convert the header of the data packet.

8. The apparatus according to claim 7, wherein the address cache table includes an identification (ID) of a wireless sensor network required for configuring a UDP tunnel, an ID of a node included in the wireless sensor network, a UDP port number, and an IP address of a transmission apparatus connected to the wireless sensor network.

9. The apparatus according to claim 1, wherein the data packet sent through the Internet communication tunnel includes an identifier of the Internet communication tunnel and an identifier of the specific node.

10. The apparatus according to claim 9, wherein the identifier of the Internet communication tunnel includes a user datagram protocol (UDP) port number and an Internet protocol (IP) address of a transmission apparatus connected to the wireless sensor network, and the identifier of the specific node includes an ID of the specific node and an ID of the wireless sensor network including the specific node.

11. A wireless sensor network domain name server, comprising:
a first database for storing and managing region names of a plurality of wireless sensor networks; and
a second database for storing and managing an IP address of each data packet transmission apparatus connecting each of the wireless sensor networks to the Internet,
wherein a region name of each of the wireless sensor networks is translated into an Internet protocol (IP) address of a connectable data packet transmission apparatus with reference to the first and the second databases.

12. A method for transmitting data packets between wireless sensor networks over the Internet, comprising:
(a) requesting, at a node X included in a source wireless sensor network, binding information of a destination transmission apparatus for connecting to a node Y included in a destination wireless sensor network, to a source transmission apparatus;
(b) sending, at the source transmission apparatus, a query message for obtaining the requested binding information to a wireless sensor network domain name server separately disposed on the Internet, and receiving information about the destination transmission apparatus;
(c) sending, at the source transmission apparatus, a binding request message for configuring an Internet communication tunnel to the destination transmission apparatus; and
(d) checking, at the destination transmission apparatus, a connection state of the node Y, receiving an active message when the node Y is in an active-state, sending a response message in response to the binding request message to the node X through the source transmission apparatus, and configuring the Internet communication tunnel.

13. The method according to claim 12, wherein in step (a), the binding information includes an Internet protocol (IP) address of the destination transmission apparatus and a user datagram protocol (UDP) port number of the Internet communication tunnel.

14. The method according to claim 12, wherein in step (b), the query message includes a region name of the destination wireless sensor network including the node Y.

15. The method according to claim 12, wherein in step (b), the information about the destination transmission apparatus includes an internet protocol (IP) address of the destination transmission apparatus and an identification (ID) of the destination wireless sensor network.

16. The method according to claim 12, wherein in step (c), the binding request message includes an identification (ID) of the source wireless sensor network, an ID of the node X, an internet protocol (IP) address of the source transmission apparatus, and a user datagram protocol (UDP) port number of the Internet communication tunnel.

17. The method according to claim 12, wherein in step (d), the response message responsive to the binding request message includes an identification (ID) of the destination wireless sensor network, an ID of the node Y, an internet protocol (IP) address of the destination transmission apparatus, and a user datagram protocol (UDP) port number of the Internet communication tunnel.

18. The method according to claim 12, further comprising:
sending/receiving a binding termination message between the node X and the node Y through the source transmission apparatus, the wireless sensor network domain name server, and the destination transmission apparatus, and closing the configured Internet communication tunnel, when there are no more data packets to transmit after sending/receiving the data packet.
